(19) United States
(12) Patent Application Publication
(10) Pub. No.: US 2012/0142320 A1
(43) Pub. Date: Jun. 7, 2012

(54) METHOD FOR FILTERING INCOMING CALLS TO COMMUNICATION DEVICE

(75) Inventor: JIE SUN, Shenzhen City (CN)

(73) Assignees: CHI MEI COMMUNICATION SYSTEMS, INC., New Taipei (TW); SHENZHEN FUTAIHONG PRECISION INDUSTRY CO., LTD., ShenZhen City (CN)

(21) Appl. No.: 13/006,438

(22) Filed: Jan. 14, 2011

(30) Foreign Application Priority Data
Dec. 2, 2010 (CN) 201010570599.4

(51) Int. Cl. H04M 3/42

(52) U.S. Cl. 455/414.1

(57) ABSTRACT

A method filters incoming calls to a communication device. The communication device stores at least one filter rule used to deny or accept incoming calls of a designated phone number in a designated time interval. After the at least one filter rule is activated, the communication device can process incoming calls based on the filter rule.

### BACKGROUND

1. Technical Field

The present disclosure relates to a method for filtering incoming calls to a communication device.

2. Description of Related Art

Many mobile phones are provided with firewall functions. However, these firewall functions generally include filter rules of the firewall functions that deny incoming calls of designated phone numbers. These filter functions are generally not adaptable to user requirements, such as receiving incoming calls from one's boss during meetings, or receiving incoming calls from family members during vacation.

### BRIEF DESCRIPTION OF THE DRAWINGS

FIG. 1 is a block diagram of one embodiment of a communication device.

FIG. 2 is a block diagram of one embodiment of a firewall system shown in FIG. 1.

FIG. 3 is a flowchart illustrating one embodiment of a method for filtering incoming calls to a communication device.

FIG. 4 is a flowchart illustrating one embodiment of a method for editing a filter rule shown in FIG. 3.

### DETAILED DESCRIPTION

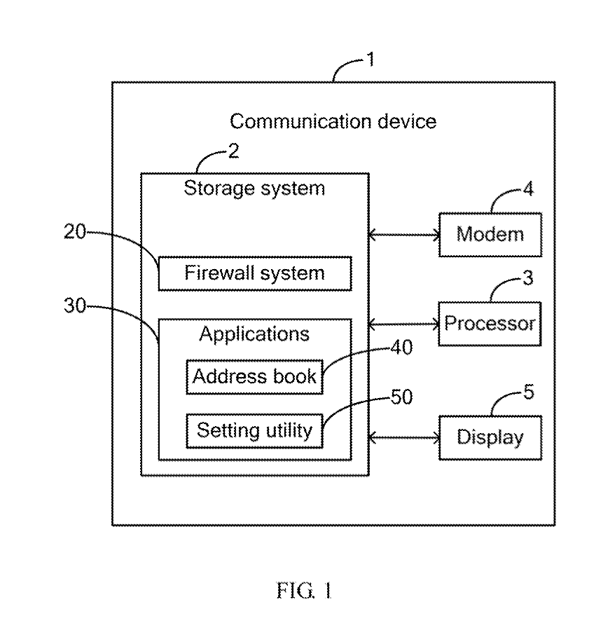

FIG. 1 is a block diagram of one embodiment of a communication device 1. The communication device 1 may be a mobile phone or a mobile Internet device (MID), for example. The communication device 1 includes a storage system 2, a processor 3, a modem 4, and a display 5. The modem 4 processes wireless signals, such as signals of incoming calls and outgoing calls of the communication device 1. The display 5 can be a LCD, for example. A firewall system 20 and applications 30 are stored in the storage system 2. The firewall system 20 includes at least one filter rule. The at least one filter rule is used to accept or deny an incoming call of a designated phone number in a designated time interval. The applications 30 may include an address book 40 and a setting utility 50. A user can edit the at least one filter rule through the setting utility 50. The designated phone number may be selected from contact information of the address book 40 or manually inputted.

In general, the word “module” as used herein, refers to logic embodied in hardware or firmware, or to a collection of software instructions, written in a programming language, such as, for example, Java, C, or Assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

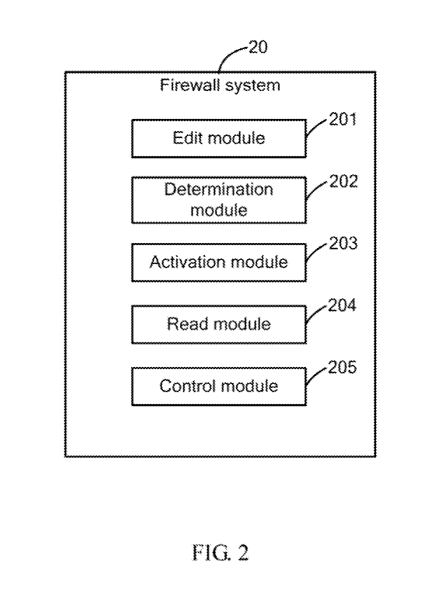

FIG. 2 is a block diagram of the firewall system 20 shown in FIG. 1. The firewall system 20 includes an edit module 201, a determination module 202, an activation module 203, a read module 204, and a control module 205. The modules 201-205 may comprise computerized code in the form of one or more programs that are stored in the storage system 2. The computerized code includes instructions that are executed by the processor 3 to provide functions for the modules 201-205.

The edit module 201 can provide an edit function to be displayed on the display 5 of the communication device 1. The edit function is used to edit the at least one filter rule in response to user requirements. The determination module 202 determines whether the at least one filter rule is activated. The activate module 203 activates the at least one filter rule. The read module 204 reads a number and a call time of an incoming call from the modem 4. The determination module 202 further determines whether the call time of the incoming call conforms to the designated time interval, and whether the number of the incoming call conforms to the designated phone number.

In a first embodiment, the control module 205 instructs the processor 3 to accept the incoming call when the call time does not conform to designated time interval if the filter rule is to deny incoming calls of the designated phone number in the designated time interval. The control module 205 instructs the processor 3 to deny the incoming call when the number of the incoming call conforms to the designated phone number if the filter rule is to deny the incoming calls of the designated phone number in the designated time interval.

In a second embodiment, the control module 205 instructs the processor 3 to deny the incoming call when the call time does not conform to designated time interval if the filter rule is to accept the incoming calls of the designated phone number in the designated time interval. The control module 205 instructs the processor 3 to accept the incoming call when the number of the incoming call conforms to the designated phone number if the filter rule is to accept the incoming calls of the designated phone number in the designated time interval.

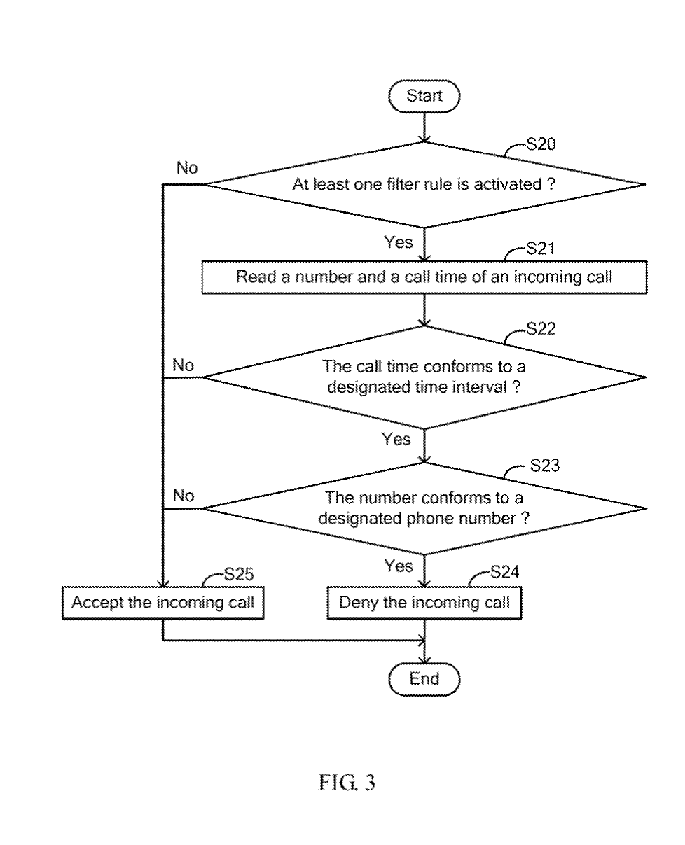

FIG. 3 is a flowchart illustrating one embodiment of a method for filtering the incoming calls to the communication device 1. Depending on the embodiment, additional blocks in the flow of FIG. 3 may be added, others removed, and the ordering of the blocks may be changed.

In block S20, The determination module 202 determines whether the at least one filter rule is activated. The filter rule may be activated by a user by manually turning off/on the filter rule by a touch screen or a physical keypad of the communication device 1. In other embodiments, the filter rule may be automatically activated in response to the user requirements. If no filter rule is activated, block S25 is implemented. In the embodiment, the at least one filter rule is to deny the incoming call of the designated phone number in the designated time interval.

If the at least one filter rule is activated, in block S21, the read module 204 reads the number and the call time of the incoming call.

In block S22, the determination module 202 determines whether the call time of the incoming call conforms to the designated time interval. If the call time does not conform to the designated time interval, block S25 is implemented.

If the call time conforms to the designated time interval, in block S23, the determination module 202 determines whether the number of the incoming call conforms to the designated phone number. If the number does not conform to the designated phone number, block S25 is implemented.

If the number conforms to the designated phone number, in block S24, the control module 205 instructs the processor 3 to deny the incoming call.

In block S25, the control module 205 instructs the processor 3 to accept the incoming call.

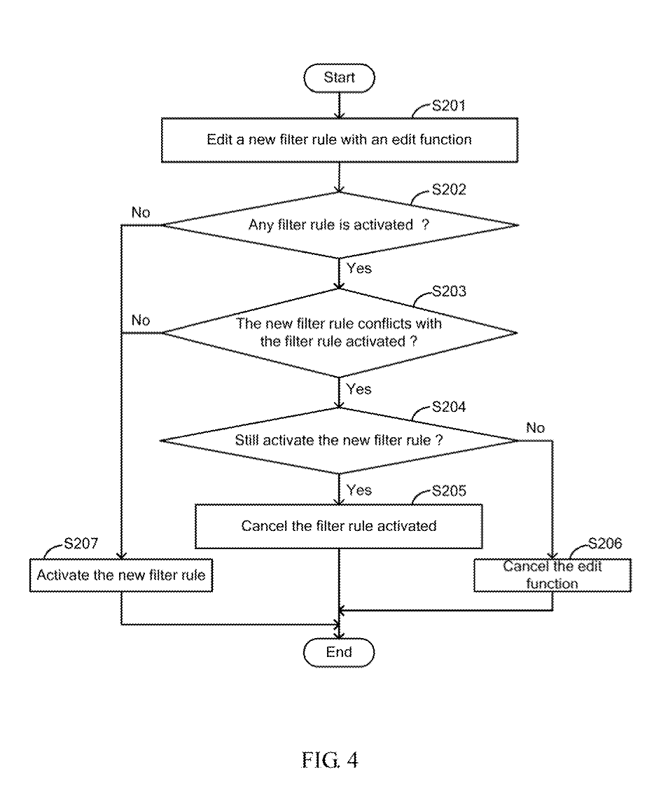

FIG. 4 is a flowchart illustrating a method for editing the filter rule shown in FIG. 3. Depending on the embodiment, additional blocks in the flow of FIG. 4 may be added, others removed, and the ordering of the blocks may be changed.

If the incoming call number is stored in the database 20, in block S20, the control module 400 deletes the incoming call number from the database 20.

In block S201, the user edits a new filter rule with the edit function.

In block S202, the determination module 202 determines whether the at least one filter rule is activated. If no filter rule is activated, block S207 is implemented.

If the at least one filter rule is activated, in block S203, the determination module 202 determines whether the new filter rule conflicts with the at least one filter rule activated. If the new filter rule does not conflict the at least one filter rule activated, block S207 is implemented.

If the new filter rule conflicts with the at least one filter rule activated, in block S204, the user may decide to still activate the new filter rule or not. If the user decides to still activate the new filter rule, in block S205, the activation module 203 cancels the at least one filter rule activated, and activate the new filter rule.

If the user decides not to activate the new filter rule, in block S206, the edit module 201 cancels the edit function.

In block S207, the activation module 203 activates the new filter rule.

The present disclosure provides a method for filtering incoming calls to a communication device. The communication device can accept or deny incoming calls of a designated phone number in a designated time interval.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for filtering an incoming call to a communication device, the communication device storing a filter rule comprising a designated time interval and a designated phone number, the method comprising:
reading a number and a call time of the incoming call;
determining whether the call time conforms to the designated time interval;
determining whether the number of the incoming call conforms to the designated phone number when the call time conforms to designated time interval; and
processing the incoming call based on the filter rule when the number of the incoming call conforms to the designated phone number.

2. The method of claim 1, further comprising:
accepting the incoming call when the call time does not conform to designated time interval if the filter rule is to deny incoming calls of the designated phone number in the designated time interval.

3. The method of claim 2, further comprising:
denying the incoming call when the number of the incoming call conforms to the designated phone number if the filter rule is to deny the incoming calls of the designated phone number in the designated time interval.

4. The method of claim 1, further comprising:
denying the incoming call when the call time does not conform to designated time interval if the filter rule is to accept incoming calls of the designated phone number in the designated time interval.

5. The method of claim 4, further comprising:
accepting the incoming call when the number of the incoming call conforms to the designated phone number if the filter rule is to accept the incoming calls of the designated phone number in the designated time interval.

6. A communication device, comprising:
a storage system;
a filter rule comprising a designated time interval and a designated phone number;
at least one processor;
one or more programs stored in the storage system and being executable by the at least one processor, the one or more programs comprising:
a read module configured to read a number and a call time of an incoming call of the communication device;
a determination module configured to determine whether the call time conforms to designated time interval, and whether the number of the incoming call conforms to the designated phone number; and
a control module configured to instruct the at least one processor to accept or deny the incoming call based on the filter rule.

7. The communication device of claim 6, wherein the control module instructs the at least one processor to accept the incoming call when the call time does not conform to designated time interval if the filter rule is to deny incoming calls of the designated phone number in the designated time interval.

8. The communication device of claim 7, wherein the control module instructs the at least one processor to deny the incoming call when the number of the incoming call conforms to the designated phone number if the filter rule is to deny the incoming calls of the designated phone number in the designated time interval.

9. The communication device of claim 6, wherein the control module instructs the at least one processor to deny the incoming call when the call time does not conform to designated time interval if the filter rule is to accept incoming calls of the designated phone number in the designated time interval.

10. The communication device of claim 9, wherein the control module instructs the at least one processor to accept the incoming call when the number of the incoming call conforms to the designated phone number if the filter rule is to accept the incoming calls of the designated phone number in the designated time interval.

11. A storage medium having stored thereon instructions that, when executed by a processor, causing the processor to perform a method for filtering an incoming call to a communication device, the communication device storing a filter rule comprising a designated time interval and a designated phone number, wherein the method comprises:
read a number and a call time of the incoming call;
determine whether the call time conforms to the designated time interval;
determine whether the number of the incoming call conforms to the designated phone number when the call time conforms to designated time interval; and
process the incoming call based on the filter rule when the number of the incoming call conforms to the designated phone number.

12. The storage medium of claim 11, wherein the method comprises:
accept the incoming call when the call time does not conform to designated time interval if the filter rule is to deny incoming calls of the designated phone number in the designated time interval.

13. The storage medium of claim 12, wherein the method comprises:
deny the incoming call when the number of the incoming call conforms to the designated phone number if the filter rule is to deny the incoming calls of the designated phone number in the designated time interval.

14. The storage medium of claim 11, wherein the method comprises:
deny the incoming call when the call time does not conform to designated time interval if the filter rule is to accept incoming calls of the designated phone number in the designated time interval.

15. The storage medium of claim 14, wherein the method comprises:
accept the incoming call when the number of the incoming call conforms to the designated phone number if the filter rule is to accept the incoming calls of the designated phone number in the designated time interval.
